(19) United States
(12) Patent Application Publication
(10) Pub. No.: US 2025/0310423 A1
(43) Pub. Date: Oct. 2, 2025

(54) APPARATUSES, METHODS, AND COMPUTER PROGRAM PRODUCTS FOR ROUTING DATA ASSOCIATED WITH A SERVER FRAMEWORK BASED ON A DATA ROUTING STRATEGY FOR A COMPONENT OF THE SERVER FRAMEWORK

(71) Applicant: ATLASSIAN PTY LTD, Sydney (AU)

(72) Inventors: Nicolas Meessen, Sydney (AU); Oliver Burn, Sydney (AU); Kieran McSwiney, Sydney (AU)

(21) Appl. No.: 19/091,607

(22) Filed: Mar. 26, 2025

Related U.S. Application Data
(60) Provisional application No. 63/571,492, filed on Mar. 29, 2024.

(51) Int. Cl. H04L 67/63; G06F 9/54

(52) U.S. Cl. CPC H04L 67/63; G06F 9/547

(57) ABSTRACT

Methods, apparatuses, or computer program products that provide for routing data associated with a server framework based on a data routing strategy for a component of the server framework. In some examples, a data routing request is received. In some examples, the data routing request includes routing context information indicative of (i) a component archetype data structure that defines a data routing strategy for data associated with a component associated with an application framework and (ii) a partition set identifier that identifies a partition set data structure associated with a set of partitions configured to store the data associated with the component. In some examples, a component identifier for the component and a partition identifier for a partition of the set of partitions are determined based on the routing context information. In some examples, routing for the data object is initiated based on the component identifier and the partition identifier.

### CROSS REFERENCE TO RELATED APPLICATIONS

This application claims the benefit of U.S. Provisional Patent Application No. 63/571,492, titled “APPARATUSES, METHODS, AND COMPUTER PROGRAM PRODUCTS FOR ROUTING DATA ASSOCIATED WITH A SERVER FRAMEWORK BASED ON A DATA ROUTING STRATEGY FOR A COMPONENT OF THE SERVER FRAMEWORK,” and filed on Mar. 29, 2024, the entirety of which is hereby incorporated by reference.

### BACKGROUND

It is often difficult to manage and/or support components of a server system in which inputs, components, and/or data storage requirements of the server system dynamically change. Through applied effort, ingenuity, and innovation, these identified deficiencies and problems have been solved by developing solutions that are configured in accordance with the embodiments of the present disclosure, many examples of which are described in detail herein.

### BRIEF SUMMARY

In an embodiment, an apparatus comprises one or more processors and one or more storage devices storing instructions that are operable, when executed by the one or more processors, to cause the one or more processors to receive a data routing request comprising a data object for a component associated with a multi-component system of an application framework. In one or more embodiments, the data routing request additionally or alternatively comprises routing context information indicative of (i) a component archetype data structure that defines a data routing strategy for data associated with the component and (ii) a partition set identifier that identifies a partition set data structure associated with a set of partitions configured to store the data associated with the component. In one or more embodiments, the instructions are additionally or alternatively operable, when executed by the one or more processors, to cause the one or more processors to determine a component identifier for the component and a partition identifier for a partition of the set of partitions based on the routing context information. In one or more embodiments, the instructions are additionally or alternatively operable, when executed by the one or more processors, to initiate routing for the data object based on the component identifier and the partition identifier.

In another embodiment, a computer program product comprises at least one non-transitory computer-readable storage medium having computer-readable program code portions stored therein, where the computer-readable program code portions comprising an executable portion are configured to receive a data routing request comprising a data object for a component associated with a multi-component system of an application framework. In one or more embodiments, the data routing request additionally or alternatively comprises routing context information indicative of (i) a component archetype data structure that defines a data routing strategy for data associated with the component and (ii) a partition set identifier that identifies a partition set data structure associated with a set of partitions configured to store the data associated with the component. In one or more embodiments, the computer-readable program code portions comprising an executable portion are additionally or alternatively configured to determine a component identifier for the component and a partition identifier for a partition of the set of partitions based on the routing context information. In one or more embodiments, the computer-readable program code portions comprising an executable portion are additionally or alternatively configured to initiate routing for the data object based on the component identifier and the partition identifier.

In yet another embodiment, a computer-implemented method comprises receiving a data routing request comprising a data object for a component associated with a multi-component system of an application framework. In one or more embodiments, the data routing request additionally or alternatively comprises routing context information indicative of (i) a component archetype data structure that defines a data routing strategy for data associated with the component and (ii) a partition set identifier that identifies a partition set data structure associated with a set of partitions configured to store the data associated with the component. In one or more embodiments, the computer-implemented method additionally or alternatively comprises determining a component identifier for the component and a partition identifier for a partition of the set of partitions based on the routing context information. In one or more embodiments, the computer-implemented method additionally or alternatively comprises initiating routing for the data object based on the component identifier and the partition identifier.

Various other embodiments are also described in the following detailed description and in the attached claims.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example system within which one or more embodiments of the present disclosure may operate;

FIG. 2 is a block diagram of an example system within which one or more embodiments of the present disclosure may operate;

FIG. 3 is a block diagram of an example data sharding apparatus configured in accordance with one or more embodiments of the present disclosure;

FIG. 4 illustrates an example data flow related to a data sharding apparatus in accordance with one or more embodiments of the present disclosure;

FIG. 5 illustrates an example data flow related to a data sharding apparatus in accordance with one or more embodiments of the present disclosure;

FIG. 6 illustrates example components dependent on other components and data sources in accordance with one or more embodiments of the present disclosure;

FIG. 7 illustrates an example application framework system in accordance with one or more embodiments of the present disclosure;

FIG. 8 illustrates an example application framework system in accordance with one or more embodiments of the present disclosure;

FIG. 9 illustrates example components dependent on other components and data sources in accordance with one or more embodiments of the present disclosure;

FIG. 10 illustrates an example diagram related to an example application framework system in accordance with one or more embodiments of the present disclosure;

FIG. 11 is a flowchart diagram for managing a database partition associated with a component of a server framework via data sharding in accordance with one or more embodiments of the present disclosure; and

FIG. 12 is a flowchart diagram for routing data associated with a server framework based on a data routing strategy for a component of the server framework in accordance with one or more embodiments of the present disclosure.

### DETAILED DESCRIPTION OF VARIOUS EMBODIMENTS

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments of the present disclosure address technical problems associated with efficiently and reliably managing server systems such as, for example, managing databases, components, and/or data objects for a server system. The disclosed techniques may be provided by an apparatus integrated with an application framework where multiple components/resources and/or layers of components/resources interact with one another in several complex manners to provide collaborative applications and/or collaborative services. Various embodiments of the present disclosure additionally or alternatively address technical problems associated with providing data sharding and/or routing communications for data objects of a server system.

An application framework (e.g., a cloud application framework) is typically characterized by a large number of the application components (e.g., services, microservices, and the like) that are offered by the application framework. Those application components typically include a large number of frontend application components and/or a large number of backend application components. One example application framework might include an enterprise instance of Jira®, an action tracking and project management software platform, developed by Atlassian Pty. Ltd. that may be licensed to Beta Corporation. Other software platforms may serve as application frameworks (e.g., Confluence®, Trello®, Bamboo®, Clover®, Crucible®, etc. by Atlassian Pty. Ltd) as will be apparent to one of ordinary skill in the art in view of the foregoing discussion.

Due to the scale and the numerosity of the application components, a large number of data objects may be generated by the application framework during a time interval. These created data objects may be generated for a variety of purposes and may be difficult to manage due to the sheer volume data objects and due to the complexity of the application framework. For example, the application framework may be configured as a collaborative application framework and data objects may be generated as a result of events, incidents, changes, component requests, alerts, notifications, workflows, service requests, service tickets, and/or other dynamic data related to the collaborative application framework. The data objects generated by an application framework may also relate to a business or enterprise that has deployed or licensed the application framework for managing events, incidents, changes, component requests, alerts, notifications, workflows, service requests, service tickets, and/or other dynamic data. Additionally, to further add to the complexity of the application framework, data objects may be transmitted via multiple types of communication channels such as, for example, email, application portals, widgets, chat channels, application programming interface (API) calls, etc.

To manage the scale, numerosity, and/or complexity of the data objects, an application framework may store one or more portions of data objects and/or related data for an application component in a partition of a monolithic database designated for the application component. For example, an application framework typically utilizes a cell-based architecture for databases where data cells are typically inefficiently partitioned and are often comprised of data related to multiple components. In some examples, one or more partitions of a monolithic database may be interconnected via a partition set and one or more partition sets may be associated with one or more application components. For example, an application component may have a partition of a partition set allocated to the application component such that data objects with relation to the application component may be stored in the partition. In some examples, data objects related to the application component may be identified based on an identifier for the application component. A partition may be a logical boundary that defines which data hosted by an application component is to be stored therein. For example, a partition may store data objects of any particular metric or logic such as, for example, a particular type, origin, location, etc.

However, it may still be difficult for an application framework utilizing partition data structures to manage data objects given the complexity and scale of modern application frameworks. It may also be difficult to manage and optimize data requirements and/or computing resources related to application components of such application frameworks. Such application frameworks may also be unable to provide a data sharding model for certain individual application components while simultaneously configuring other application components to utilize a database management model that stores data within a single database (e.g., monolithic databases). Moreover, it may also be difficult to handle routing data structures and requests between application components and partitions related to events, incidents, changes, component requests, alerts, notifications, workflows, service requests, service tickets, and/or other dynamic data related to an application framework. For instance, to handle a service-to-service call, an application framework needs to be able to determine the source service, target service, and their respective partitions. In a non-limiting example, consider a scenario in which it is desirable for Beta Corporation to manage collaborative portions of a service management process such as, for example, an information technology service management process (or another type of application component process) such that respectively components are automatically processed, routed, and/or stored in a distributive manner across databases. However, the services management processes and/or workflows may result in a vast and complex collection of data related to various services, resulting in difficulties for tracing data objects, inefficient usage of computing resources, and/or other technical drawbacks. Additionally, component processes and/or workflows typically lack an ability to perform synchronous requests to disparate partitions related to a component.

To address the above-described challenges related to managing server systems and/or databases related to server systems, various embodiments of the present disclosure are directed to systems, apparatuses, methods, and/or computer program products for providing data sharding functionality that enables data sharding for components of an application framework. In various embodiments, the data sharding functionality disclosed herein is utilized to allocate partitions for databases, queues, and/or computing resources for service deployment. Additionally or alternatively, the data sharding functionality disclosed herein is utilized to manage routing of partitioned cloud resources of a service to components of an application framework. In various embodiments, partitioned cloud resources of a service may include partitioned database systems, partitioned data queues, partitioned computing resources, and/or one or more other partitioned cloud resources of the service. In various embodiments, the data sharding functionality may be integrated within an application framework system. The data sharding functionality may also interact with control-plane APIs, network components, a service proxy communicatively coupled between a client device and a server framework, database systems, and/or an application framework.

In various embodiments, the data sharding functionality may be agnostic of the many of the configurations of the underlying components and services, enabling easy and flexible adoption of data sharding within an application framework system. For example, the data sharding functionality may allow data sharding to be gradually adopted for components and/or cloud resources in an application framework system environment comprised of numerous heterogeneous components (e.g., numerous heterogeneous services or microservices). The data sharding functionality may also enable components (e.g., services or microservices) to perform synchronous requests to data partitions and/or component archetypes to address complexities of component dependencies in an application framework system.

The data sharding functionality may be used to support compliance with enterprise deployment strategies, resiliency against system failures, scalability of resources for services, quick start up times for services, data recovery, etc. In various embodiments, the data sharding functionality may be provided on top of an existing application framework platform so that existing components and/or cloud resources may be uniquely configured for optimized data sharding functionality. In this regard, the data sharding functionality may transition a component from monolithic database functionality to the data sharding functionality. For instance, the data sharding functionality may manage partitioning and routing required for data sharding related to the component. In some examples, the data sharding functionality may manage routing decisions between components of an application framework and partitioned cloud resources by leveraging consistencies outlined by the data sharding functionality. In some examples, the data sharding functionality may manage routing decisions between components of an application framework and partitioned database systems, partitioned data queues, partitioned computing resources, and/or one or more other partitioned cloud resources of the service by leveraging consistencies outlined by the data sharding functionality. The data sharding functionality provides an outline for routing context information which can be integrated into requests, calls, queues, messages, resources, or the like, for the application framework.

In one or more embodiments, the data sharding functionality can leverage a component archetype data structure which represents a type of a service. For example, a component of an application framework that provides a service of an enterprise may be associated with a component archetype data structure which defines a data routing strategy for the component. The component represents a self-contained instance of the component archetype data structure and inherits the capabilities of the containing component archetype data structure. The concept of the component archetype data structure is introduced above the existing component to allow incremental delivery of new functionalities, optimized functionality, and/or increased performance of the system without restructuring from the ground up or causing change to existing components. Additionally, encryption may be provided per data shard based on a user-managed key.

In various embodiments, the data sharding functionality leverages a formalized partition of the data sharding functionality described herein. A partition may be hosted by a component and is an identifiable entity such that the data sharding functionality may provide lifecycle management for a partition. For instance, a partition may be migrated to support a change in a policy that governs a partition (e.g., Data Residency compliance).

By employing the data sharding functionality disclosed herein to manage components and routing of data related to an application framework, computing resources and/or memory allocation with respect to processing and storage of data for the application framework may be improved. In doing so, various embodiments of the present disclosure make substantial technical contributions to improving the efficiency and/or the effectiveness of an application framework. Various embodiments of the present disclosure additionally or alternatively provide improved resiliency, management, and efficiency of database management, improved cross-product collaboration, improved scalability, improved service stability, improved usability, improved data quality, improved interactions, with respect to data related to an application framework.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The term “component” or “application component” refers to a computer functionality or a set of computer functionalities, such as the retrieval of specified information or the execution of a set of operations, with a purpose that different clients may reuse for their respective purposes, together with the policies that should control its usage, for example, based on the identity of the client (e.g., an application, another component, etc.) requesting the component. Additionally, a component may support, or be supported by, at least one other component via a component dependency relationship. For example, a translation application stored on a smartphone may call a translation dictionary component at a server in order to translate a particular word or phrase between two languages. In such an example the translation application is dependent on the translation dictionary component to perform the translation task.

In some embodiments, a component is offered by one computing device over a network to one or more other computing devices. Additionally, the component may be stored, offered, and utilized by a single computing device to local applications stored thereon and in such embodiments a network would not be required. In some embodiments, components may be accessed by other components via a plurality of APIs, for example, JavaScript Object Notation (JSON), Extensible Markup Language (XML), Simple Object Access Protocol (SOAP), Hypertext Markup Language (HTML), the like, or combinations thereof. In some embodiments, components may be configured to capture or utilize database information and asynchronous communications via message queues (e.g., Event Bus). Non-limiting examples of components include an open source API definition format, an internal developer tool, web based HTTP components, databased components, and asynchronous message queues which facilitate component-to-component communications.

In some embodiments, a component may represent an operation with a specified outcome and may further be a self-contained computer program. In some embodiments, a component from the perspective of the client (e.g., another component, application, etc.) may be a black box (e.g., meaning that the client need not be aware of the component's inner workings). In some embodiments, a component may be associated with a type of feature, an executable code, two or more interconnected components, and/or another type of component associated with an application framework.

In some embodiments, a component may correspond to a service (e.g., a web service). Additionally or alternatively, in some embodiments, a component may correspond to a library (e.g., a library of components, a library of services, etc.). Additionally or alternatively, in some embodiments, a component may correspond to one or more modules. Additionally or alternatively, in some embodiments, a component may correspond to one or more machine learning models. For example, in some embodiments, a component may correspond to a service associated with a type of service, a service associated with a type of library, a service associated with a type of feature, a service associated with an executable code, two or more interconnected services, and/or another type of service associated with an application framework. The term “component object identifier” refers to one or more data items or elements by which a component object may be uniquely identified. The component object identifier may include, for example, one or more of Internet Protocol (IP) addresses associated with a component, Uniform Resource Locators (URLs) associated with a component, numerical characters, alphabetical characters, alphanumeric codes, American Standard Code for Information Interchange (ASCII) characters, encryption keys, identification certificates, the like, or combinations thereof. An example embodiment of a component object identifier may comprise data provided by at least a component author, for example, a URL and a payload associated with a component. In some embodiments, the payload comprises a JSON formatted text that is either posted, by way of an HTTP POST, to a component when a resource is created or returned from a component, through an HTTP GET, when at least a resource is requested from the component.

The term “application framework” refers to a computing environment associated with one or more computing devices and one or more components (e.g., one or more application components), where the environment enables interactions with respect to components supporting at least one application. For example, an application framework may be a system (e.g., a server system, a cloud-based system, an enterprise system, etc.) where multiple components, multiple resources associated with components, multiple layers of components, and/or multiple layers of resources interact with one another in several complex manners. In some embodiments, the components are associated directly or indirectly with an application supported by the components. In some embodiments, the components may support the application over one or more communication networks. The application framework may include one or more components to generate and update a repository of collected information for each component (e.g., an event object repository). Accordingly, the application framework may provide for the collection of information, in the form of event objects, to facilitate monitoring of event streams associated with one or more components of the application framework. In certain embodiments, the application framework may be configured as a collaborative application framework that manages one or more collaborative applications such as, for example, one or more collaborative document applications, collaborative software development applications, and/or one or more other types of collaborative applications. In certain embodiments, the application framework may be configured as an enterprise instance of a collaboration and knowledge base component platform for managing documents and/or encouraging collaboration among users. In certain embodiments, the application framework may be configured as a service management software platform. In certain embodiments, the application framework may alternatively be configured to manage one or more project management applications, one or more work management applications, one or more software development applications, one or more product development applications, one or more portfolio management applications, or one or more other types of applications. In certain embodiments, the application framework may be configured as an enterprise instance of an information technology service management software platform. However, it is to be appreciated that, in other embodiments, the application framework may be configured as another type of component platform.

The term “application framework system” refers to a system that includes both a server framework and a repository framework to support the server framework. For example, an application framework refers to a system that includes a computing environment associated with one or more computing devices and one or more components, as well as a repository of collected information for each component and/or each computing device.

The term “application,” “app,” or similar terms refer to a computer program or group of computer programs designed for use by and interaction with one or more networked or remote computing devices. In some embodiments, an application refers to a mobile application, a desktop application, a command line interface (CLI) tool, or another type of application. Examples of an application comprise workflow engines, component desk incident management, team collaboration suites, cloud components, word processors, spreadsheets, accounting applications, web browsers, email clients, media players, file viewers, videogames, and photo/video editors. An application may be supported by one or more components either via direct communication with the component or indirectly by relying on a component that is in turn supported by one or more other components.

The term “service” refers to a type of component. In some embodiments, a service provides a visual representation of one or more data structures. In some embodiments, a service is configured for viewing data, searching for data, creating data, updating data, managing relationships among data, assigning attributes related to data, and/or storing data associated with one or more data structures. In some embodiments, a service is configured as a system, tool or product to facilitate viewing data, searching for data, creating data, updating data, managing relationships among data, assigning attributes related to data, and/or storing data associated with one or more data structures. In some embodiments, a service comprises a set of metadata attributes associated with a technical capability, a technical configuration, an application capability, an application configuration, and/or another metadata attribute. In some embodiments, a service is published to one or more client devices via one or more APIs. In some embodiments, a service is a logical representation of an application stack. In some embodiments, a service corresponds to one or more microservices. In some embodiments, a service represents a self-contained instance of a component archetype data structure. In some embodiments, a service may own resources, provide capabilities, inherit capabilities of a containing component archetype data structure, and the like.

The term “microservices” refers to a set of services that are interconnected and independently configured to provide a monolith service. In some embodiments, a microservice is configured with one or more APIs integrated with one or more other microservices and/or one or more other applications. In some embodiments, a microservice is a single-function module with a defined set of interfaces and/or a defined set of operations configured to integrate with one or more other microservices and/or one or more other applications to provide a monolith service.

The term “dependency relationship” or similar terms refer to an exchange of data and/or functionality between a first component and a second component. For example, the first component may be directly dependent upon the second component for a DNS lookup. In some embodiments, the second component may be directly dependent upon a third component whereby the first component is transitively dependent upon the third component via the second component. As such, the dependency relationship may be a direct relationship comprising two components or it may be a transitive relationship comprising a plurality of components. In some embodiments, a first component and a second component may have a plurality of dependency relationships between them. For example, the second component may perform both a lookup and access log function for the first component.

The terms “internal component,” “internal resource,” or similar terms refer to a program, application, platform, or component that is configured by a developer to provide functionality to another one or more of their programs, applications, platforms, or components, either directly or indirectly through one or more other components, as opposed to using an external component. Internal components operate on a compiled code base or repository that is at least partially shared by an application which utilizes the functionality provided by the internal component. In some embodiments, the application code base and the internal component code base are hosted on the same computing device or across an intranet of computing devices. An application communicates with internal components within a shared architectural programming layer without external network or firewall separation. In some embodiments, an internal component is used only within the application layer which utilizes the internal components functionality. Information related to internal components may be collected and compiled into component objects which may also be referred to as internal component objects. An example embodiment of an internal component is a load balancer configured for routing and mapping API and/or component locations. Internal components may be configured for information-based shard routing, or in other words, routing and mapping API and/or component locations based on predefined custom component requirements associated with an application. For example, an internal component may be configured to identify where communication traffic originates from and then reply to the communications utilizing another component for reply communication.

The terms “external component,” “external resource,” “remote resource,” or similar terms refer to a program, application, platform, or component that is configured to communicate with another program, application, platform, or component via a network architecture. In some embodiments, communications between an external component and an application calling the external component takes place through a firewall and/or other network security features. The external component operates on a compiled code base or repository that is separate and distinct from that which supports the application calling the external component. The external components of some embodiments generate data or otherwise provide usable functionality to an application calling the external component. In other embodiments, the application calling the external component passes data to the external component. In some embodiments, the external component may communicate with an application calling the external component, and vice versa, through one or more APIs. For example, the application calling the external component may subscribe to an API of the external component that is configured to transmit data. In some embodiments, the external component receives tokens or other authentication credentials that are used to facilitate secure communication between the external component and an application calling the external component in view of the applications network security features or protocols (e.g., network firewall protocols). An example embodiment of an external component may include cloud components (e.g., AWS®).

The term “repository” refers to a database, a datastore, and/or a memory device which is accessible by one or more computing devices for retrieval and storage of one or more data components, the like, or combinations thereof. The repository may be configured to organize data components stored therein in accordance with one or more particular data classification labels or other attributes attributed to the data component (e.g., a scoring metric, file size, file type, etc.). For example, a repository may be structured in accordance with one or more data components associated with one or more services, applications, data classification labels, internal resources, external resources, network functions, APIs, the like, or combinations thereof. In some embodiments, a repository may be at least partially stored on one or more of a server, remotely accessible by a computing device, or on a memory device on-board the computing device.

The term “component archetype data structure” refers to a data entity that represents a type of component (e.g., a type of service) for a set of components. In some embodiments, a component archetype data structure provides a representation of one or more components of a certain type. In some embodiments, a component archetype data structure may provide capabilities of a component and/or a set of components. Additionally or alternatively, a component archetype data structure may define one or more strategies for routing data, traffic, or the like, of a component and/or a set of components. In some embodiments, a component archetype data structure may be instantiated by one or more components. In some embodiments, a component archetype data structure includes a component descriptor (e.g., a service descriptor) that contains information about the component archetype data structure, such as capabilities of the component archetype data structure, one or more components associated with the component archetype data structure and their respective capabilities, configurations, and the like. In some embodiments, component archetype data structure configurations are stored centrally and made available to other systems, for example, an entity or apparatus configured as a cloud provisioner.

The term “data sharding” refers to a technique for segmenting and/or distributing data related to a component across two or more partitions. Data sharding may refer to sharding with respect to various cloud resources such as, for example, databases, datastores, computing resources, data queues, memory systems, and/or the like. In some embodiments, data sharding may refer to database sharding with respect to a database and/or a datastore of an application framework system.

The term “partition” refers to a collection of data that is stored in a database, a datastore, memory, and/or the like of an application framework system. In some embodiments, a partition is a logical boundary that defines a collection of data hosted by a component of an application framework and/or configured according to domain rules associated with a domain entity. In some embodiments, a partition may be a portion of a database allocated to a particular component, resource, queue, and/or the like of an application framework. Additionally, a partition may be used to store data or a subset of data. For example, a partition may store one or more data objects associated with a component. By way of example, a component storing data may split a large table of data into smaller tables of data, each smaller table containing some subset of the overall data referred to as a partition. In another example, a component may store frequently accessed information in one partition and store infrequently accessed information in another partition. In another example, a component may store information from one region in one partition and store information from another region in another partition. In another example, data related to a data queue may be stored in one or more partitions. In yet another example, data related to computing resources may be stored in one or more partitions.

In some embodiments, a partition may be associated with one or more policies. For example, a partition may be configured in compliance with one or more security polices, risk mitigation policies, standardization policies, compatibility policies, and the like. In some embodiments, a partition may be associated with a component object identifier such as a partition identifier. A partition identifier may, for example, include a defined format. In some embodiments, a partition identifier may be used in an API call or other network communication to a component of an application framework to read or write some data stored within the respective partition. By way of example, the call may reference the partition identifier in a header associated with a synchronous call. In another example, the call may reference the partition identifier in an attribute of a message.

In some embodiments, a partition may be created, merged, migrated, duplicated, deleted, and the like. In some embodiments, management of a partition is handled by a cloud provisioner, component, control-plane API, or the like. In some embodiments, creating a partition includes allocating resources to the partition identifier.

The term “partition set” refers to a collection of data that is stored in one or more partitions. In some embodiments, a partition set is a logical boundary (e.g., a context boundary or bounded context) that defines one or more partitions and may be configured according to domain rules associated with a domain entity. A partition set may be associated with only one partition for each component archetype data structure. For example, for a given partition set and component archetype data structure, there may be only one unique relationship mapping to an associated partition and component. In this manner, a partition set and component archetype data structure tuple may be used to retrieve a respective partition and component associated with the partition set and component archetype data structure.

In some embodiments, a partition set may be associated with one or more policies. For example, a partition set may be configured in compliance with one or more security polices, risk mitigation policies, standardization policies, compatibility policies, and the like. In some embodiments, a partition set may be associated with a component object identifier such as a partition set identifier that uniquely identified a partition set. A partition set identifier, may, for example, include a defined format. In some embodiments, a partition set identifier may be globally unique, opaque, nonrecyclable, and the like. In some embodiments, a partition set identifier may be used in an API call or other network communication to a component of an application framework to read or write some data stored within the respective partition set. The call may, for example, reference the partition set identifier in a header associated with a synchronous call. Additionally or alternatively, the call may, for example, reference the partition identifier in an attribute of a message.

In some embodiments, a partition set may be directly associated with either a component of an application framework or a partition. In some embodiments, a partition set may be merged into another. In such cases, a tombstone for the original partition set may be used to support routing requests associated with the original partition set that no longer exists but is subsumed by another partition set as a result of the merge.

The term “partition set registry” refers to a data storing information associated with partition sets. For example, a partition set registry may be updated to reflect the creation, deletion, merging, and the like, of a partition set. A partition set registry may include relationship information, routing information, policy information, ownership information, and the like associated with a partition set.

The term “component registry” refers to data storing one or more partition set data structures containing information about relationships between partition sets, partitions, components, and component archetype data structures. For example, a component registry may be used in combination with a tuple that specifies a component archetype data structure and a partition set identifier to retrieve a component identifier and partition identifier associated with the tuple.

The term “partition set data structure” refers to a data entity that maps a relationship between a partition set, partition, component, and component archetype data structure stored in a component registry. In some embodiments, a partition set data structure maps a relationship between a partition set, a component, and a component archetype data structure stored in a partition set registry.

The term “routing” refers to an action and/or transmission of data such as, for example, a data object via a communication channel, path or mapping used to propagate the data between applications, components, databases, partitions, queues, resources, and/or the like. In various embodiments, routing may be based on one or more routing criteria related to an application framework system and/or a communication channel. Managing routing decisions may ensure consistency on how the appropriate components, partitions, partition sets, queues, resources, and/or the like are used when making calls or requests within an application framework. For example, in a component-to-component call, routing context information can be determined to transmit the call from the first component to the second component. Additional routing context information may need to be determined, for example, to update one or more partitions or data storage locations for each component responsive to the call. In some embodiments, routing context information may be predetermined. In other embodiments, routing context information may be determined dynamically at runtime.

In some embodiments, a component of an application framework that supports data sharding may not adopt a data sharding model, and to avoid allocating unnecessary partitions to the component, a partition set may be directly related to the component. In another example where a component does adopt a data sharding model, a partition set may be directly related to one or more partitions that may be directly related to the component. In any case, routing context information for the application framework needs to be determined to appropriately propagate data through the system. Routing context information may be determined from or included within a routing request. For example, in a component-to-component call, the call may specify a current partition set and current partition along with a target partition set and target component archetype data structure. Accordingly, a target component and target partition may be looked up using the target partition set and target component archetype data structure. In some embodiments, if a target partition set is not specified, a current partition set may be used by default. In some embodiments, a partition set registry and/or component registry is used to determine routing context information.

The term “service proxy” refers to an intermediary network entity for handling requests between different components of an application framework. In some embodiments, a service proxy provides or supports routing, security, optimization, and the like for one or more associated components. By way of example, a client device may provide a request related to a component of an application framework via the service proxy. The request may be received by the service proxy which, in turn, may perform an evaluation of the request and/or any subsequent action based thereon (e.g., routing the request to the component).

In some embodiments, a service proxy may be configured to determine routing context information for an API call or other network communication (e.g., a data routing request) associated with a component. In some embodiments, a service proxy is configured to support mapping from routing context information. For example, a service proxy may receive a request comprising routing context information, use the routing context information to determine a target component archetype data structure and target partition, and determine a target service and target partition therefrom.

The term, “routing context information” refers to supplementary routing data associated with an API call, network communication, message, request, and the like. For example, routing context information may include information related to the source or target of a request, resources related to the request, headers and/or attributes associated with the request, identifiers associated with the request, and the like. In some embodiments, routing context information may be or include a HTTP header, URL, and the like. In some embodiments, calls, messages, requests, and the like may be required to include routing context information that includes or maps to information such as a partition identifier or partition set identifier. For example, routing context information of a request may map to a current partition and current partition set of the request. In some embodiments, if a request does not specify a target partition set, a current partition set from routing context information may be assumed by default.

The term, “cloud provisioner” refers to an entity, apparatus, or circuitry configured to manage various sharding operations associated with one or more components of an application framework. In some embodiments, the cloud provisioner corresponds to a data sharding apparatus. In some embodiments, the cloud provisioner manages a set of APIs to provide cloud provisioning related to components of an application framework via data sharding management and/or routing. In some embodiments, the cloud provisioner is responsible for the lifecycle management of one or more partitions, such as creating, merging, migrating, duplicating, deleting, and the like. In some embodiments, the cloud provisioner is configured to call a control-plane API configured to manage one or more partitions. By way of example, deleting a partition may be associated with a synchronous call that may be processed asynchronously where the cloud provisioner does not wait for a response. In another example, deleting a partition may be associated with a message sent to an SQS queue allowing decoupling of the cloud provisioner and the associated component.

In some embodiments, the cloud provisioner may be configured to perform migration of a partition from a source component to a target component. For example, migration of a partition with down-time may include putting the partition hosted by a source component into a read-only mode to prevent updates. Additionally or alternatively, the source component may have down-time and stop all requests associated with the component. The source component may then be called to copy the data for the partition into a data bucket, for example, a S3 bucket. If necessary, the data bucket may be moved, for example, to the cloud computing and/or server region of the target component. The target component may then be called to load the data for the partition from the data bucket. A record associated with the partition may then be updated to route traffic to the new target component before deleing the partition on the source component.

In some embodiments, migration of a partition without down-time may include calling the source component to migrate a partition to a target component. In response, the component may deploy a custom logic, for example, logic configured by a domain entity associated with the component. The component may notify the cloud provisioner upon completion of the migration. In response, a record associated with the partition may then be updated to route traffic to the new target component before deleting the partition on the source component.

In some embodiments, managing a partition includes provisioning a partition to a new domain entity associated with different domain rules for a component. In some embodiments, managing a partition requires the cloud provisioner to factor in criteria such as the policies that apply to a domain entity associated with a partition, the capabilities that domain rules of a partition requires when selecting a component to allocate a partition on, creating partition set data structures for the partitions that a respective domain rules will require, the associated relationships, and the like. In some embodiments, the cloud provisioner may factor in the above criteria when managing the domain entity associated with a partition becoming entitled to access new component, the domain entity associated with a partition losing access to a component, changes in policies that apply to the domain entity associated with a partition, migrating partitions between components, and the like.

The term, “domain entity” refers to a data entity, device, or system that manages one or more domain rules for a component, partition, and/or partition set associated with an application framework. In some embodiments, a domain entity corresponds to a user identifier that owns and/or manages one or more components associated with an application framework. The term user identifier refers to one or more items of data by which a particular user of the application framework may be uniquely identified. For example, a user identifier may correspond to a particular set of bits or a particular sequence of data that uniquely identifies a user. In various embodiments, a user identifier corresponds to a user that is authorized to view, edit and/or work simultaneously on a collaborative document, collaborative software development, and/or another type of collaborative application along with one or more other user identifiers. In some embodiments, a user identifier corresponds to a user related to particular subset of data and/or components of an application framework. In some embodiments, a domain entity is associated with a client device such as, for example, a user device, a mobile device, a portable digital assistant (PDA), a mobile telephone, a smartphone, a computer, a laptop computer, a tablet computer, a wearable, or another type of client device.

The term, “component archetype deployment functionality” refers to an entity, apparatus, or circuitry configured to configure and manage a component archetype data structure. In some embodiments, the component archetype deployment functionality is configured to facilitate viewing data, searching for data, creating data, updating data, managing relationships among data, assigning attributes related to data, and/or storing data associated with one or more data structures. By way of example, the component archetype deployment functionality may be a command line tool associated with a command line interface. For example, the component archetype deployment functionality may be a command-line tool that is integrated into Atlas. In some embodiments, the component archetype deployment functionality may include support in a preexisting deployment tools (e.g., Spinnaker) so that existing components maintain operational states. By way of example, the component archetype deployment functionality may allow a domain entity associated with a component to configure the component under a component archetype model. In some embodiments, the component archetype deployment functionality may include a mechanism for tracking the state of deployments for a component archetype data structure. In some embodiments, the component archetype deployment functionality enables lifecycle management of components associated with a component archetype data structure. In some embodiments, the component archetype deployment functionality may be able to generate and configure a component descriptor for the component archetype data structure of a component. In some embodiments, deployment of a component associated with a component archetype data structure is managed by the component archetype deployment functionality. In some embodiments, the component archetype deployment functionality may be directly callable by a domain entity associated with a component, for example, to handle disaster recovery contingencies. In some embodiments, the component archetype deployment functionality is configurable on a per component archetype data structure basis to support different use cases such as only allowing a select number (e.g., 2) versions of a component to be deployed, performing progressive rollouts of a new version of a component, managing running different editions of a component, and the like.

The term, “policy” represents a course of action adopted to implement a rule. For example, a policy may define one or more criteria necessary for implementing a component in compliance with one or more regulations. In some embodiments, a policy may require capabilities that need to be provided by a component associated with the policy. For example, a policy may be defined by or associated with FedRAMP, Unified Policy Platform, Data Residency, and the like. For example, partition migration may be necessary to support when a policy governing a partition changes, such as for Data Residency compliance.

As used herein, the term “duplicate” with reference to a partition refers to a duplicate instance or copy of a partition and/or related data that serves to replicate the operational state, architecture, and stored data of the replicated partition. In some embodiments, the duplicate partition may be configured to copy the data stored in a duplicate partition such that the stored data in the duplicate partition may be accessed to support functions of an associated software application when the primary partition is offline or otherwise no longer accessible.

The term “manage” with respect to a data object refers to one or more actions performable for altering a data object and/or information therein. Non-limiting examples of actions for managing a data object include deleting a data object, creating a data object, editing a portion of information embodied by and/or otherwise stored in a data object, altering the state of a data object, and/or altering access to a data object.

The term “maintain” with respect to a data object and/or an application refers to a state of read and/or write access to a memory or other storage for persistently and/or temporarily storing the data object by the application. In some such contexts, an application that maintains a data object is permissioned to directly alter information embodied by and/or stored in the data object.

The term “capability” refers to a functionality or compliance that may be offered. In some embodiments, a capability contains a key and a value. For example, a capability may contain a key “HIPPA” and a value “true”.

The term “realm” represents a geographical space that data of an application framework is persisted within. In some embodiments, a real may, for example, span one or more geographic, cloud computing and/or server regions (e.g., one or more AWS regions).

The term “region” represents a physical location which may host resources and components. In some embodiments, a region is mapped to a particular region supported by, for example, AWS or another cloud computing or server system.

The term “interaction signal” refers to a signal received by one or more computing devices (e.g., servers, systems, platforms, etc.) which are configured to cause an application framework system to perform one or more actions associated with one or more components of the application framework system. The interaction signal may be received via a component management interface, an API, a communication interface, the like, or combinations thereof. In one or more embodiments, the interaction signal may be generated by a client device via one or more computer program instructions. In various embodiments, an interaction signal may be generated via a collaborative application, event, event stream, or the like. Additionally or alternatively, the interaction signal may cause one or more actions, one or more changes, and/or one or more predictive inferences with respect to a collaborative application, event, event stream, or the like.

The term “interface element” refers to a rendering of a visualization and/or human interpretation of data associated with an application framework and/or a distributed ledger system. In one or more embodiments, an interface element may additionally or alternatively be formatted for transmission via one or more networks. In one or more embodiments, an interface element may include one or more graphical elements and/or one or more textual elements.

The term “visualization” refers to visual representation of data to facilitate human interpretation of the data. In some embodiments, visualization of data includes graphic representation and/or textual representation of data.

The term “graphical control element” refers to a computer input element that allows a user to enter input to facilitate one or more actions with respect to an application framework.

The term “interface area” refers to an area of an electronic interface, where the area may be situated in relation to one or more other interface areas of the electronic interface. An interface area may be comprised of groupings of pixels, or may be defined according to coordinates of a display device configured to render the interface. A size of an interface may be adjusted according to parameters associated with the display device. An interface area may include one or more interface elements. For example, an interface element may include a visualization. In certain embodiments, an interface area may include one or more graphical elements and/or or more textual elements. In certain embodiments, an interface area may be void of an interface element and/or a visualization. In certain embodiments, an interface area may include a graphical control element and/or one or more other interactive interface elements.

Thus, use of any such terms, as defined herein, should not be taken to limit the spirit and scope of embodiments of the present disclosure.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a PDA, mobile telephone, smartphone, laptop computer, tablet computer, wearable, the like or any combination of the aforementioned devices.

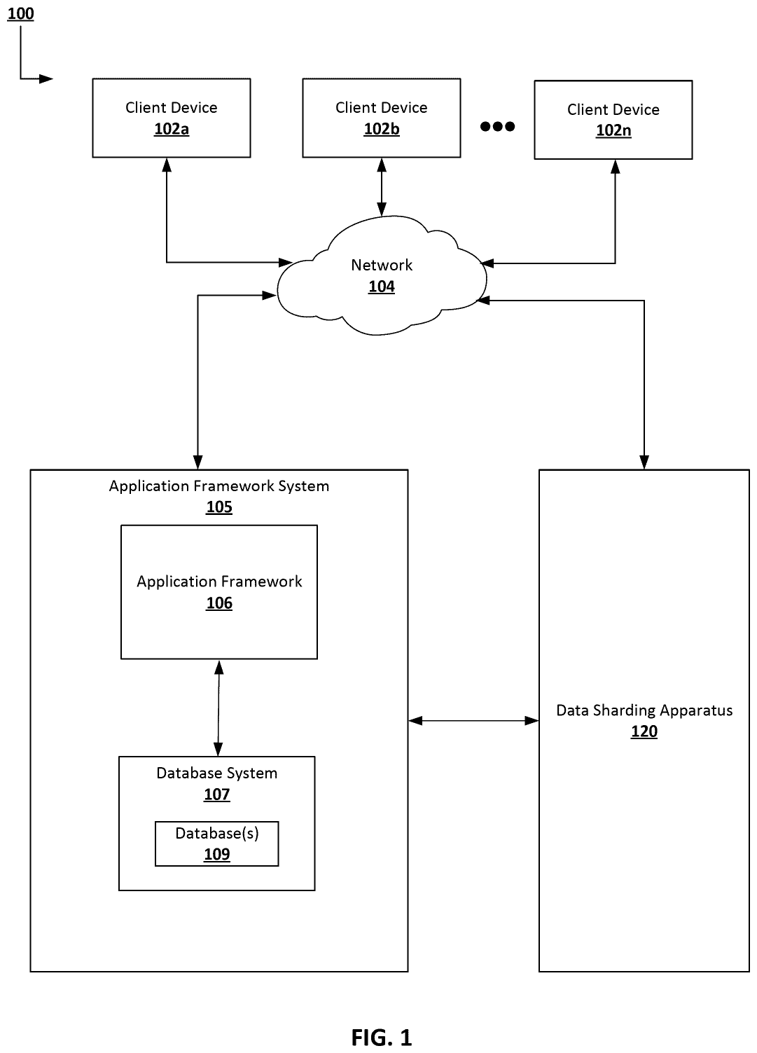

FIG. 1 illustrates an example system architecture 100 within which embodiments of the present disclosure may operate. The system architecture 100 includes an application framework system 105 configured to interact with one or more client devices 102a-n, such as client device 102a, client device 102b, and/or client device 102n. In one or more embodiments, the one or more client devices 102a-n may be configured to interact with one or more components managed by an application framework 106 of the application framework system 105. For example, in one or more embodiments, the one or more client devices 102a-n may be configured to send data to the one or more components managed by the application framework 106 and/or receive data from the one or more components managed by the application framework 106. In one or more embodiments, the one or more components may interact with one another in several complex manners to provide collaborative applications and/or collaborative services.

In one or more embodiments, the application framework system 105 includes a database system 107 associated with one or more databases 109. The databases 109 may store data associated with one or more components, data queues, computing resources, and/or the like managed by the application framework 106. For example, the database system 107 may store data for one or more component objects and component object dependencies in one or more databases 109. The one or more databases 109 may be configured to support data sharding. For example, a database 109 of database system 107 may include one or more partition sets, such as multiple distributed partition sets that are connected through a computer network. Each partition set may include one or more partitions configured to store at least one of one or more data assets and/or one or more data about the computed properties of one or more data assets. Moreover, each partition set in the database system 107 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

In some embodiments, the database system 107 may include one or more databases 109 associated with one or more partition sets containing one or more partitions associated with one or more component objects and component object dependencies. In some embodiments, the data included in database system 107 is distributed to the one or more partitions. For example, the data of the databases 109 may be stored into one or more partitions associated with one or more partition sets. A component registry and/or partition set registry may track and maintain relationships between the partitions, partition sets, and component objects related to a multi-component system of an application framework. For example, a component registry may be configured to store one or more partition set data structures indicative of a relationship mapping between a partition set, a partition, a component, and a component archetype data structure of the component. In another example, a partition set registry may be configured to store one or more partition set data structures indicative of a relationship mapping between a partition set, a component, and component archetype data structure of the component, for example, in a case where the component is not configured in accordance with a data sharding model.

The system architecture 100 also includes a data sharding apparatus 120. In an embodiment, the data sharding apparatus 120 is implemented separate from the application framework system 105. Alternatively, in certain embodiments, the application framework system 105 may include the data sharding apparatus 120. In various embodiments, the application framework system 105 and/or the data sharding apparatus 120 may also be configured to interact with the one or more client devices 102a-n. In various embodiments, the data sharding apparatus 120 may be configured to interact with application framework system 105. For example, in one or more embodiments, the data sharding apparatus 120 may be configured to interact with and/or manage one or more components of the application framework 106 and one or more databases 109 of the database system 107. In some embodiments, the data sharding apparatus 120 is configured to partition one or more databases 109 into one or more partitions. In some embodiments, the data sharding apparatus 120 is configured to associate one or more partitions to a partition set associated with one or more databases 109. In some embodiments, the data sharding apparatus 120 is configured to allocate one or more partitions and/or partition sets to a component or other partitioned cloud resource of the application framework 106. In some embodiments, the data sharding apparatus 120 is configured to manage routing context information between one or more components of the application framework 106 and one or more partition sets and/or partitions of the databases 109.

The application framework system 105, the data sharding apparatus 120, and/or the one or more client devices 102a-n may be in communication using a network 104. Additionally or alternatively, in various embodiments, the application framework system 105 and the data sharding apparatus 120 may be in communication via a backend network and/or an enterprise network separate from the one or more client devices 102a-n. The network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

A client device from the one or more client devices 102a-n may include a mobile device, a smart phone, a tablet computer, a laptop computer, a wearable device, a personal computer, an enterprise computer, a virtual reality device, or another type of computing device. In one or more embodiments, a client device from the one or more client devices 102a-n includes geolocation circuitry configured to report a current geolocation of the client device. In some embodiments, the geolocation circuitry of the client device may be configured to communicate with a satellite-based radio-navigation system such as the global position satellite (GPS), similar global navigation satellite systems (GNSS), or combinations thereof, via one or more transmitters, receivers, the like, or combinations thereof. In some embodiments, the geolocation circuitry of the client device may be configured to infer an indoor geolocation and/or a sub-structure geolocation of the client device using signal acquisition and tracking and navigation data decoding, where the signal acquisition and tracking and the navigation data decoding is performed using GPS signals and/or GPS-like signals (e.g., cellular signals, etc.). Other examples of geolocation determination include Wi-Fi triangulation and ultra-wideband radio technology.

In one or more embodiments, the application framework system 105 may be configured to receive one or more interaction signals from one or more of the client devices 102a-n. An interaction signal refers to a signal configured to cause one or more actions with respect to the application framework 106. For example, an interaction signal may be a signal configured to cause one or more actions with respect to one or more computing devices and or one or more components managed by the application framework 106. An interaction signal may be generated by the one or more client devices 102a-n and may be received via a component management interface of the application framework 106, an API of the application framework 106, a communication interface of the application framework 106, the like, or combinations thereof. Based on the one or more interaction signals, the application framework system 105 may perform one or more actions with respect to the application framework 106. In various embodiments, the one or more actions may be associated with one or more user identifiers associated with one or more events with respect to one or more components of the application framework 106. For example, the one or more actions may initiate and/or correspond to one or more events with respect to one or more components of the application framework 106. In certain embodiments, the one or more actions may be associated with one or more events with respect to a one or more computing devices and or one or more components managed by the application framework 106. In certain embodiments, the one or more actions may be associated with one or more user identifiers with respect to one or more computing devices and or one or more components managed by the application framework 106.

In some embodiments, the data sharding apparatus 120 may manage and/or configure one or more components of the application framework system 105 and/or one or more databases 109 of the database system 107. In one or more embodiments, the data sharding apparatus 120 may allocate one or more partitions of a partition associated with a database 109 to a component or other partitioned cloud resource of the application framework 106. In one or more embodiments, the data sharding apparatus 120 may determine and/or perform routing associated with a database 109 and/or a component of the application framework 106. In one or more embodiments, the data sharding apparatus may manage a component and/or database 109 of the application framework 106.

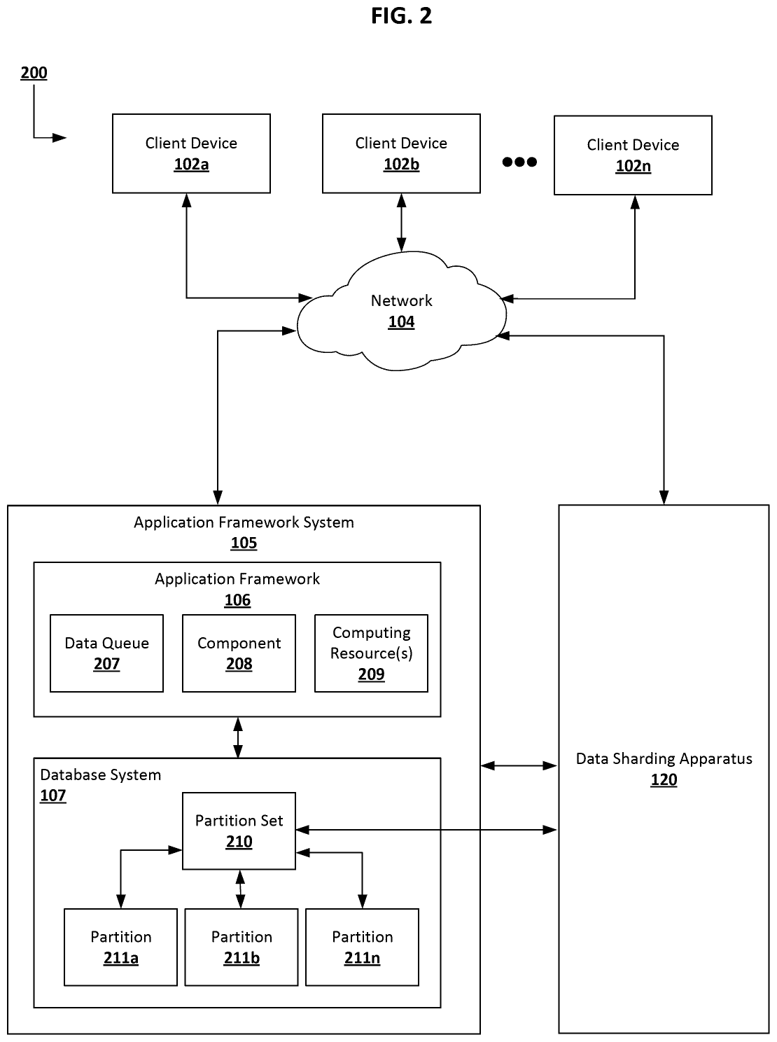

FIG. 2 illustrates an example system architecture 200 within which embodiments of the present disclosure may operate. The system architecture 200 includes the application framework system 105, application framework 106, database system 107, client devices 102a-n, network 104, and data sharding apparatus 120. Application framework 106 includes data queue 207, component 208, and/or and computing resource(s) 209. The component 208 may be a component (e.g., an application component or an application service) offered by application framework 106. In various embodiments, the component 208 may be associated with the data queue 207 and/or the computing resource(s) 209. For example, a data object may be routed to the component 208 via the data queue 207 and one or more operations associated with the component 208 may be performed by the computing resource(s) 209. In various embodiments, the database system 107 may include one or more partitions for sharding the data queue 207, the component 208, and/or the computing resource(s) 209 of the application framework 106. In various embodiments, the component 208 is associated with partition set 210 of database system 107. Partition set 210 is associated with partitions 211a-n. For example, data associated with component 208 may be stored in one of the partitions 211a-n of partition set 210. Data sharding apparatus 120 is associated with application framework system 105 and partition set 210 for direct management. For example, data sharding apparatus 120 may be configured to allocate one or more partitions 211a-n of the partition set 210 to the component 208 of application framework 106. In some embodiments, the data sharding apparatus 120 may be configured to update, delete, merge, duplicate, and/or the like, one or more partitions 211a-n of the database system 107. In some embodiments, the data sharding apparatus 120 may be configured to manage the partition set 210 of database system 107. For example, the data sharding apparatus may manage a partition set registry and/or a component registry to reflect one or more partition set data structures reflective of relationship mappings between a partition, partition set, component, and/or a component archetype data structure. In some embodiments, data sharding apparatus 120 is configured to manage routing context information between component 208 and the database system 107. For example, data sharding apparatus 120 may assist in routing data from component 208 to an associated partition 211a-n in response to a request, call, or the like. In some embodiments, the data sharding apparatus 120 may be configured to manage the component 208 by configuring and/or deploying a component archetype data structure of the component 208. Additionally or alternatively, the data sharding apparatus 120 may be configured to manage the data queue 207 by configuring and/or deploying a component archetype data structure of the data queue 207. Additionally or alternatively, the data sharding apparatus 120 may be configured to manage the computing resource(s) 209 by configuring and/or deploying a component archetype data structure of the computing resource(s) 209.

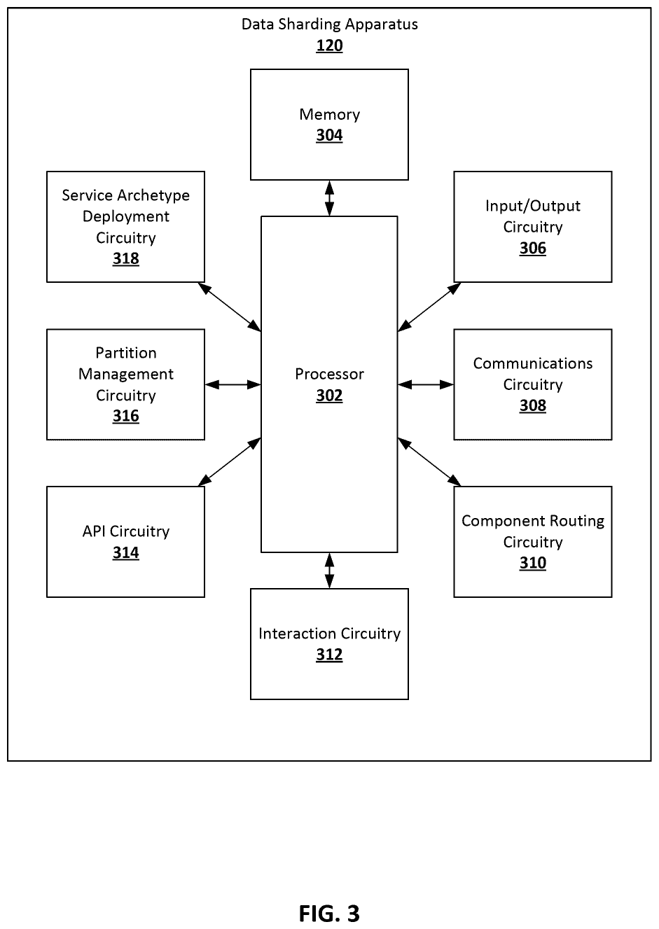

The data sharding apparatus 120 may be embodied by one or more computing systems, such the data sharding apparatus 120 illustrated in FIG. 3. In one or more embodiments, the graphical representation apparatus 120 may include processor 302, memory 304, input/output circuitry 306, communications circuitry 308, component routing circuitry 310, interaction circuitry 312, API circuitry 314, partition management circuitry 316, and/or component archetype deployment circuitry 318. The data sharding apparatus 120 may be configured to execute the operations described herein. Although these components 302-318 are described with respect to functional limitations, it should be understood that the particular implementations necessarily include the use of particular hardware. It should also be understood that certain of these components 302-318 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may be configured to store information, data, content, applications, instructions, or the like for enabling the apparatus to carry out various functions in accordance with example embodiments of the present disclosure.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present disclosure while configured accordingly. Alternatively, as another example, when the processor 302 is embodied as an executor of software instructions, the instructions may specifically configure the processor 302 to perform the algorithms and/or operations described herein when the instructions are executed.

In some embodiments, the data sharding apparatus 120 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like. In some embodiments, the input/output circuitry 306 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the data sharding apparatus 120. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally or alternatively, the communications circuitry 308 may include the circuitry for interacting with the antenna/antennae to cause transmission of signals via the antenna/antennae or to handle receipt of signals received via the antenna/antennae.

The component routing circuitry 310 may be any means such as a device or circuitry embodied in either hardware or a combination of hardware and software that is configured to interact with components of an application framework 106. In some embodiments, the component routing circuitry 310 may act as an intermediary for one or more components of an application framework. For example, the component routing circuitry 310 may receive and process requests, call, messages, and the like for one or more components of an application framework 106. In some embodiments, the component routing circuitry 310 may support data routing, traffic control, security, optimization, and/or the like for component 208 of application framework 106. For example, component routing circuitry 310 may receive a request and perform one or more subsequent actions based on the request. In some embodiments, component routing circuitry 310 may provide functionality of a service proxy for one or more components of an application framework 106.

In some embodiments, the database system 107 may comprise one or more of a single unified repository, a single partitioned repository, or a plurality of isolated repositories comprising one or more partitions. An example embodiment of database system 107 may comprise separate partitions 211a-n for isolating information for respective component identifiers. The interaction circuitry 312 may also be configured to generate access logs and/or historical data including information associated with a particular computing device, component, component object, the like, or combinations thereof.

In some embodiments, the database system 107 includes existing databases containing relationship data. In some embodiments, the databases 109 of the database system 107 are specific to a component of the application framework system 105 and do not contain relationships across multiple components. In some cases, the databases 109 of the database system 107 are shared across multiple components of the application framework. For example, a first component may be associated with a first partition of a database 109 and a second component may be associated with a second partition of the same database 109. In such a case, component routing circuitry 310 may be used to determine appropriate routing between the components and their respective partitions of the database 109. In one or more embodiments, the component routing circuitry 310 is configured to connect data across a plurality of components of the application framework system 105.

The interaction circuitry 312 may be any means such as a device or circuitry embodied in either hardware or a combination of hardware and software that is configured to interact with the application framework system 105 and/or the one or more client devices 102a-n. In various embodiments, the interaction circuitry 312 may monitor, analyze, and/or process data associated with the application framework system 105 such as, for example, data stored in the database system 107 and/or data related to a collaborative application. For example, in various embodiments, the interaction circuitry 312 may monitor event streams associated with the application framework 106 to detect respective candidate actions related to components of the application framework 106. In certain embodiments, the interaction circuitry 312 may be configured to retrieve metadata associated with the application framework 106 and/or the database system 107 to facilitate detection of respective candidate actions related to components of the application framework 106. The metadata may include, for example, data associated with relationships, sources, targets, ownership, consumption, libraries, activities, attributes, incidents, communication channels, dashboards, data repositories, labels, descriptions, and/or other data related to the application framework 106 and/or the database system 107.

In some embodiments, to facilitate monitoring of event streams, the interaction circuitry 216 may be configured to ping one or more computing devices of the application framework 106, such as via an internet control message protocol, to receive information related to one or more components of the application framework 106. In some embodiments, to obtain event objects associated with the one or more components, the interaction circuitry 216 utilizes the communications circuitry 208 to transmit one or more API calls to one or more API servers associated with the noted client devices.

The API circuitry 314 may be any means such as a device or circuitry embodied in either hardware or a combination of hardware and software that is configured to manage operations of various embodiments described herein. In various embodiments, the API circuitry 314 may be configured to interact with the application framework 106 and/or the data sharding apparatus 120. For example, the API circuitry 314 may be configured to manage the lifecycle of various components of an application framework 106. Additionally or alternatively, the API circuitry 314 may be configured to retrieve metrics related to the resources consumed by partitions of the database system 107. Additionally or alternatively, the API circuitry 314 may be configured to support partition management and may be utilized by one or more other circuitries of the data sharding apparatus 120 to create a partition, delete a partition, migrate a partition between components of the application framework 106, and or the like.

The partition management circuitry 316 may be any means such as a device or circuitry embodied in either hardware or a combination of hardware and software that is configured to generate and manage a partition set and/or partition of a database system 107. For example, partition management circuitry 316 may be configured to generate, merge, migrate, duplicate, delete, update, and/or the like, a partition of a partition set. In some embodiments, partition management circuitry 316 is configured to call a control-plane API to perform one or more operations associated with the partition management circuitry 316.

The component archetype deployment circuitry 318 may be any means such as a device or circuitry embodied in either hardware or a combination of hardware and software that is configured to generate and manage a component archetype data structure of a component of an application framework 106. For example, the component 208 of the application framework 106 may be associated with a component archetype data structure that is configured by the component archetype deployment circuitry 318. The component archetype deployment circuitry 318 may include a command line tool configured to perform one or more operations associated with the component archetype deployment circuitry 318. In some embodiments, the component archetype deployment circuitry 318 enables lifecycle management of components associated with a component archetype data structure. In some embodiments, component archetype deployment circuitry 318 is used to generate and configure a component descriptor for a component archetype data structure of a component. For example, the component archetype deployment circuitry 318 may be used to configure information about a component archetype data structures capabilities, the components that may be generated from the component archetype data structure and their capabilities, specific environment overrides, resource overrides, configurations, and the like.

In some embodiments, one or more external systems (such as a remote cloud computing and/or data storage system) may also be leveraged to provide at least some of the functionality discussed herein.

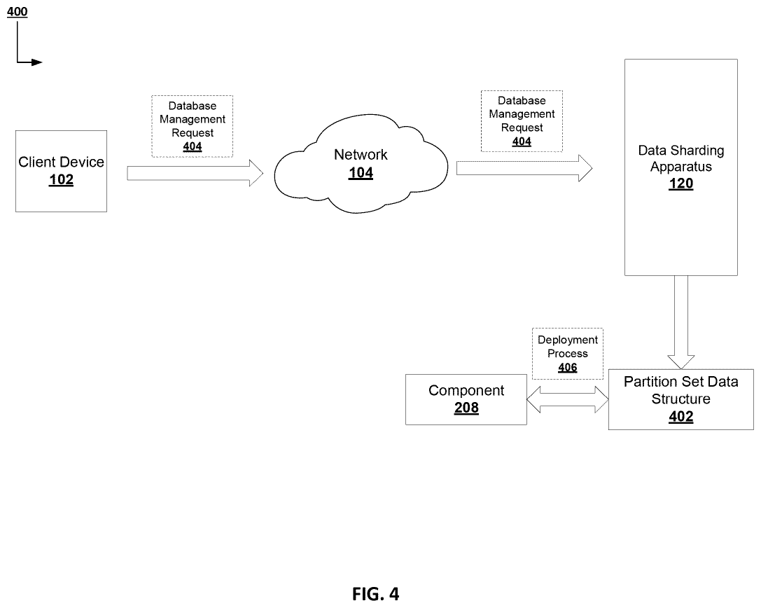

Referring to FIG. 4, an example data flow 400 is presented in accordance with one or more embodiments of the present disclosure. The data flow 400 depicts functionality between various sub-systems of the present disclosure, including the client device 102, network 104, data sharding apparatus 120, one or more partition set data structures 402, and component 208. In one or more embodiments, data sharding apparatus 120 may receive a sharding request 404 via network 104 from a client device 102. The sharding request 404 may, for example, be a request to provide data sharding for a component 208 of an application framework. In some embodiments, a sharding request may be a request to provide data sharding for cloud resources such as, for example, database systems, data queues, computing resources, and/or the like. For example, a sharding request may be a request to provide data sharding for the data queue 207, the computing resource(s) 209, and/or the database system 107. In some embodiments, the sharding request 404 may be configured as an interaction signal. In some embodiments, the sharding request 404 may be generated via a graphical control element of an electronic interface of the client device 102.

In some embodiments, the data sharding apparatus 120 may perform one or more operations in response to the sharding request 404. For example, the data sharding apparatus 120 may configure a database (e.g., database 109) to provide sharding for the component 208 based on the sharding request 404. In some examples, the data sharding apparatus 120 may configure and/or allocate one or more partitions of the database to component 208. In some embodiments, the data sharding apparatus 120 allocates a partition of the database to the component 208 via the partition management circuitry 316. In some embodiments, the data sharding apparatus 120 may utilize one or more capabilities and/or policies when allocating a partition to component 208. Additionally or alternatively, the data sharding apparatus 120 may generate a partition set data structure 402 and store it in a component registry and/or partition set registry. For example, the data sharding apparatus 120 may generate a partition set data structure 402 indicative of a relationship mapping between the component 208, the partition allocated to the component 208, a partition set of the partition, and a component archetype data structure associated of the component 208. The data sharding apparatus 120 may also store the partition set data structure 402 in a component registry.

In some embodiments, the data sharding apparatus 120 may determine a component archetype data structure and a partition identifier in response to the sharding request 404. The component archetype data structure may define a data routing strategy for data associated with the component identifier. The partition identifier may identify a partition of a database that is allocated to the component identifier. Additionally, the data sharding apparatus 120 may generate the partition set data structure 402 that defines a relationship mapping between the component identifier, the component archetype data structure, and the partition identifier. In some embodiments, the component archetype data structure may represent a type of service provided by a combination of the component 208 and one or more other components of the application framework. In some embodiments, the component archetype data structure may include a component descriptor indicative of capabilities of the component 208 and one or more other components associated with the component archetype data structure. In some embodiments, the component archetype data structure may include a component descriptor indicative of a number of instances deployment of the component 208 via the application framework.

In some embodiments, the data sharding apparatus 120 may deploy the component 208 in a deployment process 406. For example, the data sharding apparatus 208, via the component archetype deployment circuitry 318, may configure a component archetype data structure for the component 208 and deploy the component 208 to an application framework server. In some embodiments, the deployment of the component 208 may be correlated to the partition set data structure 402. In some embodiments, deployment of the component 208 may include routing and/or storage of data (e.g., one or more data elements) associated with the component 208 via one or more partitions of the database 109.

In some embodiments, the data sharding apparatus 120 may generate a partition set identifier for the partition set data structure 402. Additionally, the data sharding apparatus 120 may generate routing context information for the component 208. The routing context information may be indicative of the component archetype data structure and the partition set identifier. Additionally, in certain embodiments, the deployment process 406 may utilize the routing context information for deployment of the component 208. In some examples, the partition identifier may be uniquely correlated to the component based on the component archetype data structure. In some embodiments, the relationship mapping may include a particular relationship mapping between the partition set identifier and the component archetype data structure.

In some embodiments, the data sharding apparatus 120 may update the component archetype data structure based on one or more changes with respect to an entity (e.g., a domain entity) associated with the partition set data structure 402. Additionally or alternatively, the data sharding apparatus 120 may update the component archetype data structure based on one or more changes with respect to one or more policies associated with the component 208. Additionally or alternatively, the data sharding apparatus 120 may update the component archetype data structure based on migration of the partition with one or more other partitions of the database (e.g., the database 109).

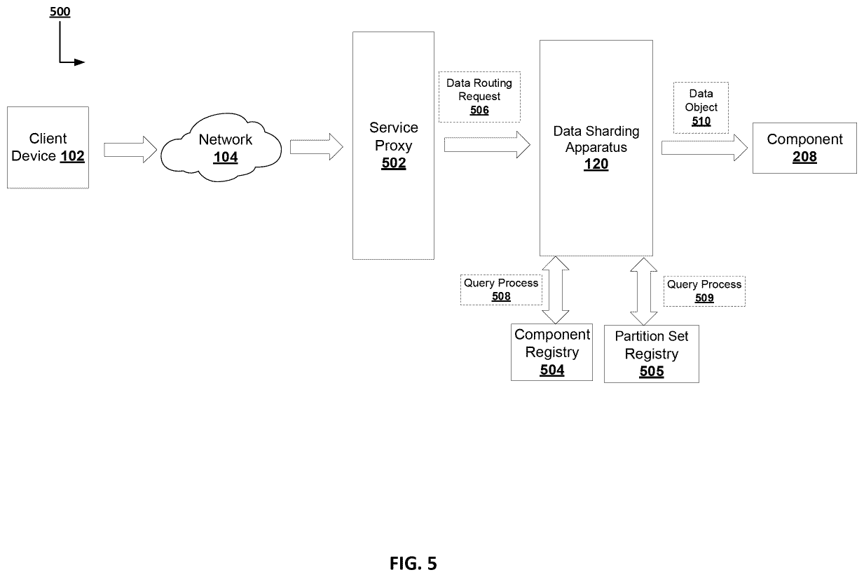

Referring now to FIG. 5, an example application framework system 500 is presented in accordance with one or more embodiments of the present disclosure. As shown, the application framework system 500 includes the client device 102, network 104, service proxy 502, data sharding apparatus 120, component 208, and component registry 504. In some embodiments, data sharding apparatus 120 receives a data routing request 506 from a client device 102 via network 104. In some embodiments, the service proxy 502 acts as an intermediary network entity between the client device 102 and the data sharding apparatus 120. For example, the service proxy 502 may receive the data routing request 506 from the client device 102 via network 104 and evaluate the data routing request 506. In some embodiments, service proxy 502 may provide one or more security, routing, optimization, routing, or the like functionalities, and perform one or more actions based thereon. For example, the service proxy 502 may determine routing context information associated with the data routing request 506 and pass the data routing request 506 and associated routing context information to the data sharding apparatus 120.

In some embodiments, the data sharding apparatus 120 may query the component registry 504 via a query process 508 to process the data routing request 506. For example, the data sharding apparatus 120 may use the data routing request 506 received from the service proxy 102 to query the component registry 504 to determine a target component (e.g., the component 208) and target partition associated with the data routing request 506. For example, data routing request 506 may initiate one or more read/write operations associated with a particular component of an application framework system and a respective partition. In some embodiments, data sharding apparatus 120 may use a target partition set and target component archetype data structure associated with data routing request 506 to query the component registry 504 in a query process 508. For example, from query process 508, the data sharding apparatus 120 may determine the target component as component 208 and determine a corresponding partition to component 208. The data sharding apparatus 120 may then transmit a data object 510 associated with routing request 506 to the component 208 and one or more read/write operations may be performed on the corresponding partition.

In some embodiments, the data routing request 506 may include the data object 510. The data object 510 may include data for the component 208 associated with an application framework (e.g., the application framework 106). Additionally or alternatively, the data routing request 506 may include routing context information. The routing context information may be indicative of a component archetype data structure that defines a data routing strategy for data associated with the component 208. Additionally or alternatively, the routing context information may be indicative of a partition set identifier that identifies a partition set data structure associated with a set of partitions configured to store the data associated with the component 208. In some embodiments, based on the routing context information, the data sharding apparatus 120 may determine a component identifier for the component 208 and/or a partition identifier for a partition of the set of partitions. In some embodiments, the routing context information may be associated with a Hypertext Transfer Protocol (HTTP) header for the data routing request.

In some embodiments, the data sharding apparatus 120 may query a partition set registry 505 via the query process 509 based on the routing context information. The partition set registry 505 may define a relationship mapping between the component archetype data structure, the partition set identifier, the component identifier, and the partition identifier. In some embodiments, the data routing request 506 may further include dependency information that defines one or more component dependency relationships between the component 208 and one or more other components associated with the application framework. Additionally, the data sharding apparatus 120 may determine the partition identifier and/or the component identifier based on the dependency information. The data sharding apparatus 120 may additionally or alternatively initiate routing for the data object 510 based on the component identifier and the partition identifier. In some embodiments, the data sharding apparatus 120 may initiate the routing based on the dependency information included in the data routing request 506. In some embodiments, the data sharding apparatus 120 may store the data object 510 in the partition based on the component identifier and the partition identifier.

In some embodiments, the data sharding apparatus 120 may generate, based on the routing for the data object 510, a metric data structure that provides dependency metrics associated with the component 208 and one or more other components of the application framework. Additionally, the data sharding apparatus 120 may generate an API object and/or one or more interface elements for an electronic interface of the client device 102 based on the metric data structure. In some embodiments, the data sharding apparatus 120 may cause transmission of the API object and/or a signal associated with the one or more interface elements to the client device 102 via a communication channel of the network 104. In some embodiments, a visualization associated with the metric data structure may be rendered via an electronic interface of the client device 102. For example, the visualization associated with the metric data structure may be rendered via one or more interface areas of the electronic interface of the client device 102.

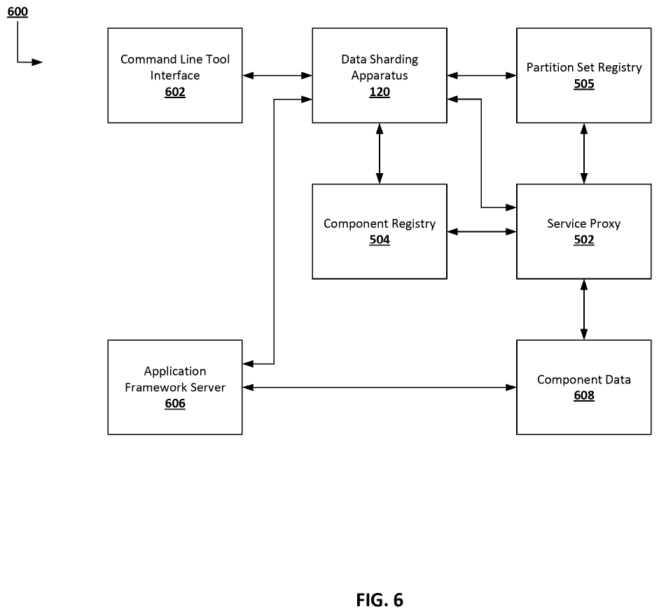

Referring now to FIG. 6, example application framework system 600 is presented in accordance with one or more embodiments of the present disclosure. As shown, the application framework system 600 includes a command line tool interface 602, data sharding apparatus 120, component registry 504, partition set registry 505, service proxy 502, application framework server 606, and component data 608. In some embodiments, the data sharding apparatus may receive a data routing request or a sharding request. For example, the service proxy 502 may receive a data routing request or a sharding request from the component data 608 and evaluate the request. In some embodiments, component data 608 may be data associated with a component hosted by application framework server 606. In some embodiments, the service proxy 502 may determine routing context information associated with a request. In response to the request, the data sharding apparatus may perform routing based on the request and/or manage one or more components and/or databases based on the request. For example, the data sharding apparatus may determine routing context information for the request including determining a target component and a target partition using the service proxy 502, the component registry 504, and/or the partition set registry 505. Additionally or alternatively, the data sharding apparatus may configure a component archetype data structure for a component associated with the request. For example, the data sharding apparatus may configure a component archetype data structure and component descriptor for a component associated with the request using the command line tool interface 602. In some embodiments, the data sharding apparatus 120 may allocate a partition of a database to a component associated with the request. In some embodiments, the data sharding apparatus 120 may update the component registry 504 with a component identifier related to a component of the application framework 106. In some embodiments, the data sharding apparatus 120 may update the partition set registry 505 with a partition data set structure that contains a relationship mapping between a partition set, component, and component archetype data structure.

In some embodiments, the application framework server 606 may service a component that does not utilize a sharding model. For example, the data sharding apparatus 120 may need to configure and/or determine routing context information associated with component data 608 for a component that does not utilize a data sharding model and is not associated with a partition. In some embodiments, the partition set registry 505 may store partition set data structures that contain relationship mappings between a partition set, a component, and a component archetype data structure, allowing a component to be configured without the use of partitions. In such a case, the data sharding apparatus may still determine and configure a component archetype data structure for the component, for example, using the command line tool interface 602.

In some embodiments, the data sharding apparatus 120 may deploy a component associated with a partition set data structure via the command line tool interface 602. For the example, the command line tool interface 602 may be configured to generate and configure a component archetype data structure for a component. In some embodiments, the data sharding apparatus 120 may deploy a component associated with a component archetype data structure, for example by using the command line tool interface 602 to deploy a component to the application framework server 606. In some embodiments, the data sharding apparatus 120 may associate a deployment of a component to a partition set data structure of the component registry 504 and/or the partition set registry 505. The command line tool interface 602 may be configured to manage the lifecycle of the component archetype data structure. The service proxy 502 may be configured to configure and manage the lifecycle of the component's data storage. For example, the service proxy 502 may be configured to manage any partition sets, partitions, and/or the creation of partition set data structures for the component. The service proxy 502 may be configured to allocate partitions to component identifiers and manage the partition set data structure within the component registry 504 and the partition set registry 505. In some embodiments, the data sharding apparatus 120 may perform one or more similar functionalities described herein to manage routing of partitioned cloud services such as, for example, partitioned database systems, partitioned data queues, partitioned computing resources, and/or other partitioned cloud resources.

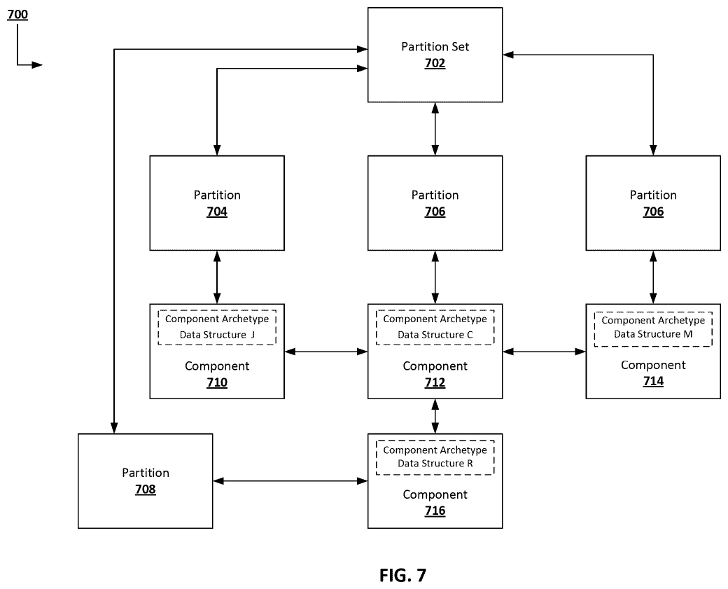

Referring to FIG. 7, an example application framework 700 is presented in accordance with one or more embodiments of the present disclosure. The application framework 700 includes the partition set 702, the partitions 704-708, and the components 710-716. The partition set 702 includes partitions 704-708. The components 710-716 each comprise a different component archetype data structure and may each be a different service offered by the application framework 700. In an example, a component-to-component call is made by the component 710 for the component 712 to store data associated with the component 714. The call from the component 710 is handled by a data sharding apparatus via a service proxy associated with the application framework. The service proxy may determine, based on routing context information associated with the call, that the target component archetype data structure for the call is the component archetype data structure C. In some embodiments, if an API call or other network communication does not specify a target partition set, a current partition set may be used by default. In the example, the call does not specify a target partition set and accordingly, the partition set 702 is used by default. Using the target component archetype data structure C and the target partition set 702, the service proxy may query a component registry to determine that the target component is component 712 and the target partition is partition 706. The data sharding apparatus may provide data associated with the call to the component 712, for example, via the service proxy. Upon receipt of the data, the component 712 may determine that the active partition for the call is the partition 706. When the component 712 provides an API call or other network communication in response to the data, the data sharding apparatus may determine, for example, via the service proxy, that the target component archetype data structure is the component archetype data structure M and that the target partition set is the partition set 702. The data sharding apparatus, for example, via the service proxy and component registry, may determine the target component is the component 714 and the target partition is partition 706 and perform any associated read/write operations necessary. Accordingly, the data sharding apparatus may perform routing and data management for the call and propagate data through the application framework 700.

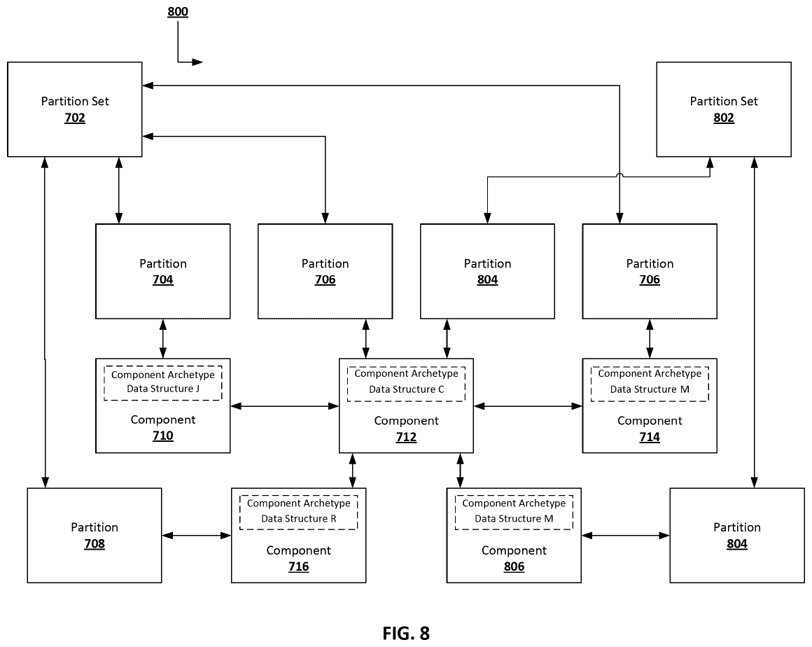

Referring to FIG. 8, an application framework 800 is presented in accordance with one or more embodiments of the present disclosure. The application framework 800 expands on the application framework depicted in FIG. 7 by introducing partition set 802 which includes partition 804 associated with component 712 and component 806. For example, an API call or other network communication made by the component 710 for the component 712 to store data associated with the component 714 would result in the same flow as in application framework 700. However, if an API call or other network communication were made by component 716 for component 712 to store some data associated with component 806, the flow is different. In an example, the component 716 provides an API call or other network communication for component 712 to store some data associated with component 806. A data sharding apparatus may determine routing context information associated with the call. For example, the data sharding apparatus, via a service proxy, may determine the target component archetype data structure is component archetype data structure C and the target partition set is partition set 802, for example from routing context information of the call. The data sharding apparatus may then, for example using the service proxy and a component registry, look up the target component archetype data structure C and partition set 802 to determine the target component is component 712 and the target partition is partition 804. The data sharding apparatus may then, for example via the service proxy, pass data associated with the call to the component 712. Upon receipt of the data, the component 712 may determine the active partition for the call is partition 804. In response to the component data, the component 712 may provide an API call or other network communication and the data sharding apparatus, for example, via the service proxy, may determine the target component archetype data structure for the call is the component archetype data structure M and the target partition set is partition set 802. Using the target component archetype data structure and the target partition set, the data sharding apparatus may determine the target component is the component 806 and the target partition is partition 804. The data sharding apparatus may then use this information to perform routing for the call and perform any associated read/write operations necessary. In this manner, routing context information may be determined using a partition set and a component archetype data structure determined from routing context information of an API call, network communication, message, request, or the like.

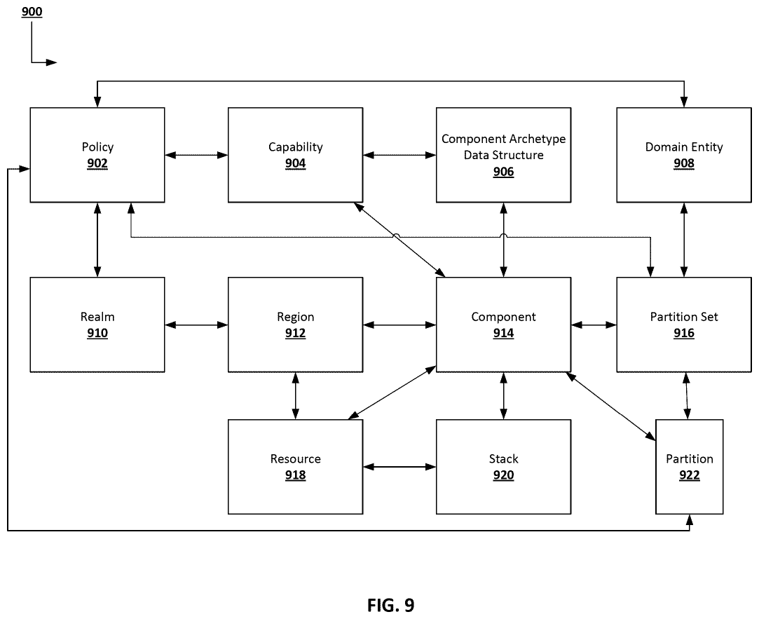

Referring to FIG. 9, an example application framework system 900 is presented in accordance with one or more embodiments of the present disclosure. The application framework system 900 includes policy 902, capability 904, component archetype data structure 906, domain entity 908, realm 910, region 912, component 914, partition set 916, resource 918, stack 920, and partition 922. In some embodiments, an application framework is associated with one or more components 914. A component 914 may correspond to a service provided by the application framework that is implemented by a stack 920. In some embodiments, a component 914 may be associated with one or more partitioned data queues. A component archetype data structure 906 represents a type of a service that a component 914 may be. Each component 914 may be associated with a component archetype data structure that contains a component descriptor and defines routing context information associated with the component 914. A component archetype data structure 906 may be associated with a plurality of different components 914. In some embodiments, a component is associated with a partition set. In some embodiments, data may propagate through an application framework from a component archetype data structure 906 to a component 914 to a partition set 916 to a partition 922. In various embodiments, data may propagate through an application framework from a component archetype data structure 906 to a component 914 to a partition set 916.

In some embodiments, a component 914 is associated with resources 918 accessible to the stack 920 that implements the component 914. In some embodiments, resources 918 are partitioned cloud resources associated with one or more partitions. In some embodiments, the component 914 is associated with a region 912 where the resources 918 are hosted. In some embodiments, a region is associated with a real 910 in which data is persisted. The component 914 is associated with partition set 916 which is owned by a domain entity 908. In some embodiments, the domain entity 908 is associated with one or more policies 902 for which a component is to be implemented in compliance with. A policy may be determined by or associated with a realm 910 and may govern one or more capabilities 904 that a component is configured to provide to one or more client devices. For example, a component 914 may be required by a policy 902 to offer various security or data residency compliances. A component archetype data structure 906 of a component 914 may define the capabilities 904 the component offers. Accordingly, a partition set 916 or partition 922 associated with a component may be selected based on the capabilities 904 and/or policies associated with a component. For example, a domain entity 908 may require that a partition 922 of a partition set 916 allocated to a component 914 is compliant with data residency policies of policy 902.

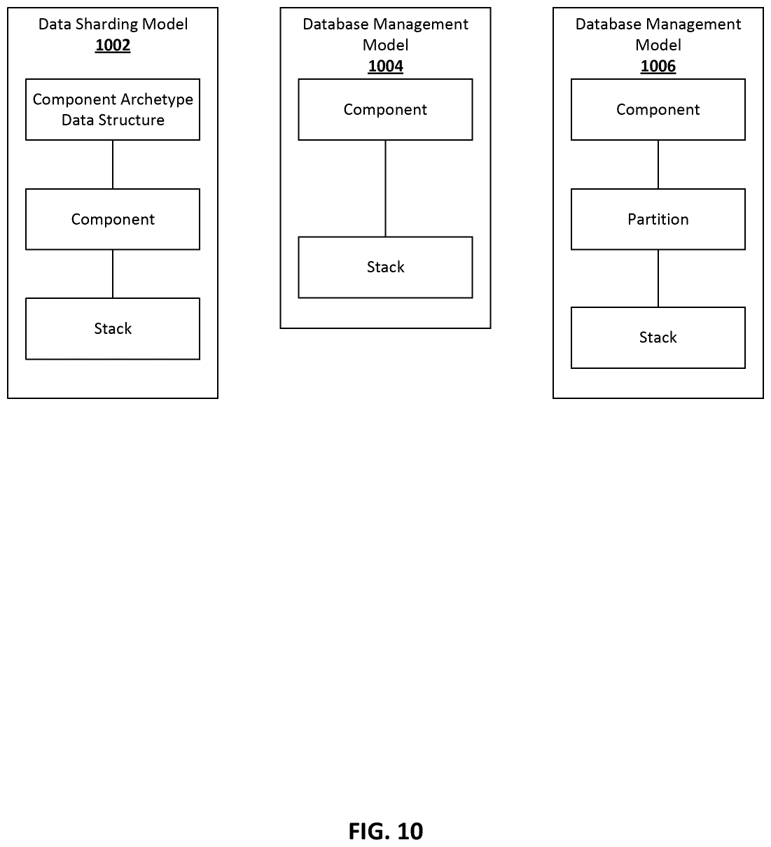

Referring to FIG. 10, an example data sharding model is presented in accordance with one or more embodiments of the present disclosure. The data sharding model 1002 depicts the data sharding model 1002 described herein as having the component archetype data structure introduced above a component of an application framework to which it is correlated. In contrast to database management model 1004 and database management model 1006, the component archetype data structure of the data sharding model 1002 allows for greater flexibility and manageable data routing for implementing data sharding via an application framework (e.g., the application framework 106). In some embodiments, the component archetype data structure of the data sharding model 1002 may define routing context information for a corresponding component. In some embodiments, the component may inherit capabilities from the component archetype data structure. By correlating a component archetype data structure to a component of the data sharding model 1002 in this manner, various embodiments of the present disclosure make it possible to incrementally deliver value to the application framework without requiring a ground up restructuring or redeployment of the application framework. For example, components of the application framework may adopt the component archetype data structure and receive data sharding services provided by the data sharding model 1002. In some embodiments, a component may opt out of receiving data sharding services and maintain, for example, a monolithic database model without adversely affecting the data sharding model 1002 or other interconnected components of the application framework that do receive data sharding services. In some embodiments, an application framework adopting the data sharding model 1002 may be executed and/or provide real-time services without providing changes to existing components as the component archetype data structure may be structure above the components.

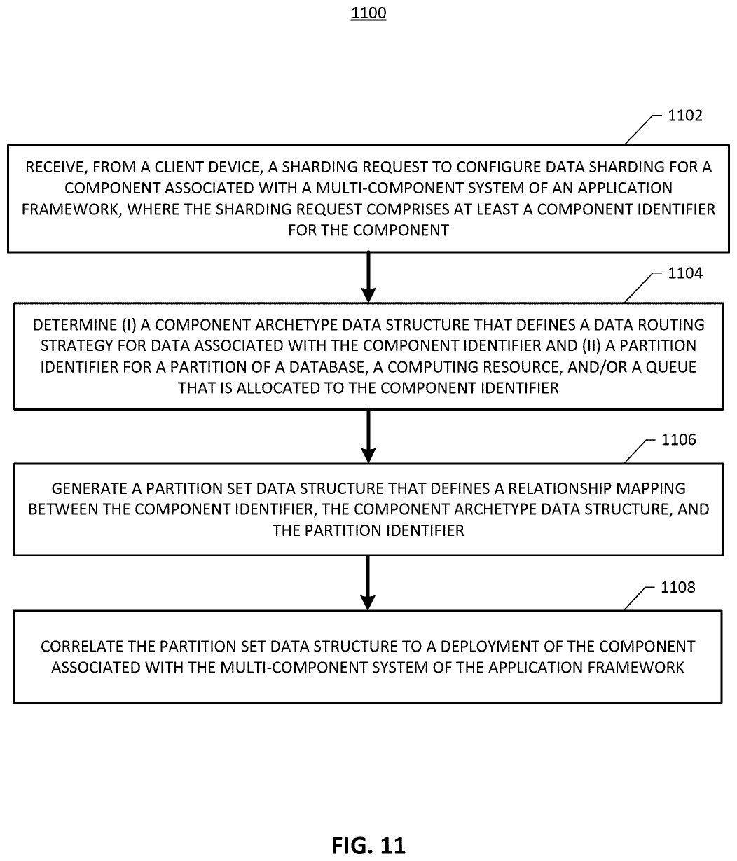

FIG. 11 is a flowchart diagram of an example process 1100 for managing a database partition associated with a component of a server framework via data sharding, in accordance with, for example, the data sharding apparatus 120. Via the various operations of process 1100, the data sharding apparatus 120 may enhance efficiency, reliability, effectiveness, and/or quality of data of the application framework 106 and/or the database(s) 109. Via the various operations of process 1100, the data sharding apparatus 120 may additionally or alternatively increase storage capacity of the database(s) 109 and/or improve load balancing for the application framework 106.

The process 1100 begins at operation 1102 where a sharding request to configure data sharding for a component associated with a multi-component system of an application framework is received from a client device, where the sharding request comprises at least a component identifier for the component. The process 1100 additionally or alternatively includes an operation 1104 that determines (i) a component archetype data structure that defines a data routing strategy for data associated with the component identifier and (ii) a partition identifier for a partition of a database, a computing resource, and/or a queue that is allocated to the component identifier. The process 1100 additionally or alternatively includes an operation 1106 that generates a partition set data structure that defines a relationship mapping between the component identifier, the component archetype data structure, and the partition identifier. The process 1100 additionally or alternatively includes an operation 1108 that correlates the partition set data structure to a deployment of the component associated with the multi-component system of the application framework.

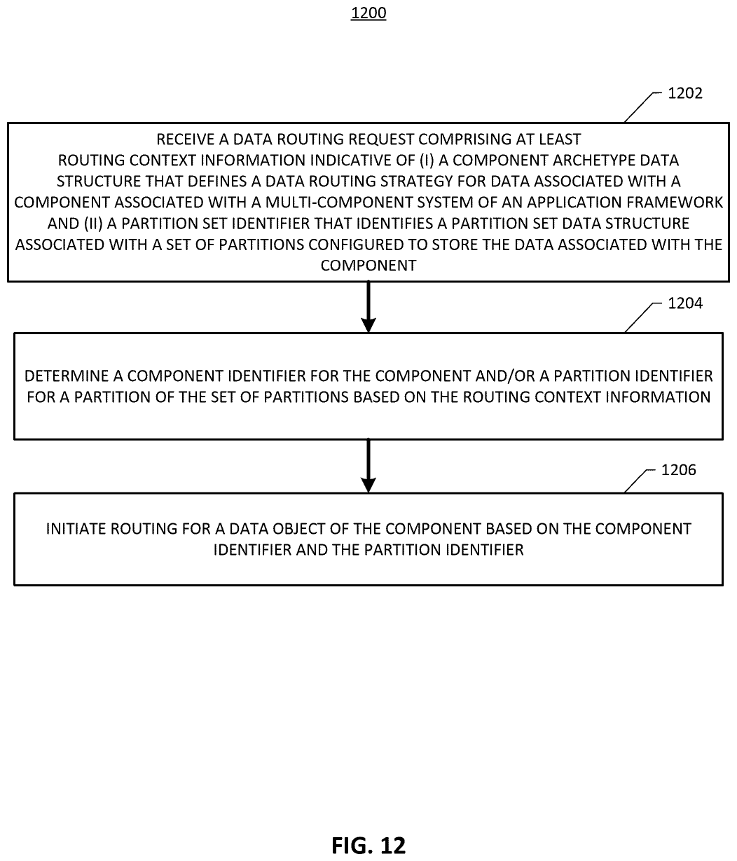

FIG. 12 is a flowchart diagram of an example process 1200 for routing data associated with a server framework based on a data routing strategy for a component of the server framework, in accordance with, for example, the data sharding apparatus 120. Via the various operations of process 1200, the data sharding apparatus 120 may enhance efficiency, reliability, effectiveness, and/or quality of data of the application framework 106 and/or the database(s) 109. Via the various operations of process 1100, the data sharding apparatus 120 may additionally or alternatively increase storage capacity of the database(s) 109 and/or improve load balancing for the application framework 106.

The process 1200 begins at operation 1202 where a data routing request is received, the data routing request comprising at least routing context information indicative of (i) a component archetype data structure that defines a data routing strategy for data associated with a component associated with a multi-component system of an application framework and (ii) a partition set identifier that identifies a partition set data structure associated with a set of partitions configured to store the data associated with the component. In some embodiments, the data routing request additionally comprises a data object for a component associated with a multi-component system of an application framework. The process 1200 additionally or alternatively includes an operation 1204 that determines a component identifier for the component and/or a partition identifier for a partition of the set of partitions based on the routing context information. The process 1200 additionally or alternatively includes an operation 1206 that initiates routing for a data object of the component based on the component identifier and the partition identifier.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

The operations described herein may be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (Application Specific Integrated Circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web components, web services, web microservices, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described herein may be implemented on a computer having a display device, e.g., a CRT (cathode ray tube) or LCD (liquid crystal display) monitor, for displaying information/data to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's query-initiating computing device in response to requests received from the web browser.

Embodiments of the subject matter described herein may be implemented in a computing system that includes a back-end component, e.g., as an information/data server, or that includes a middleware component, e.g., an application server, or that includes a front-end component, e.g., a query-initiating computing device having a graphical user interface or a web browser through which a user may interact with an implementation of the subject matter described herein, or any combination of one or more such back-end, middleware, or front-end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) may be received from the query-initiating computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising one or more processors and one or more storage devices storing instructions that are operable, when executed by the one or more processors, to cause the one or more processors to:
receive a data routing request comprising:
a data object for a component associated with a multi-component system of an application framework; and
routing context information indicative of (i) a component archetype data structure that defines a data routing strategy for data associated with the component and (ii) a partition set identifier that identifies a partition set data structure associated with a set of partitions configured to store the data associated with the component;
determine a component identifier for the component and a partition identifier for a partition of the set of partitions based on the routing context information; and
initiate routing for the data object based on the component identifier and the partition identifier.

2. The apparatus according to claim 1, wherein the one or more processors are further caused to:
receive the data routing request via a service proxy communicatively coupled to the apparatus and a client device via a network.

3. The apparatus according to claim 1, wherein the one or more processors are further caused to:
query a partition set registry based on the routing context information, wherein the partition set registry defines a relationship mapping between (a) the component archetype data structure, (b) the partition set identifier, (c) the component identifier, and (d) the partition identifier.

4. The apparatus according to claim 1, wherein the routing context information is associated with a Hypertext Transfer Protocol (HTTP) header for the data routing request.

5. The apparatus according to claim 1, wherein the one or more processors are further caused to:
generate, based on the routing for the data object, a metric data structure that provides dependency metrics associated with the component and one or more other components of the application framework;
generate an application programming interface (API) object based on the metric data structure; and
cause transmission of the API object to a client device via a communication channel of a network that communicatively couples the apparatus and the client device.

6. The apparatus according to claim 1, wherein the data routing request further comprises dependency information that defines one or more component dependency relationships between the component and one or more other components associated with the multi-component system of the application framework, and wherein the one or more processors are further caused to:
determine the partition identifier based on the dependency information.

7. The apparatus according to claim 1, wherein the one or more processors are further caused to:
store the data object in the partition based on the component identifier and the partition identifier.

8. A computer program product comprising at least one non-transitory computer readable storage medium having computer executable code portions stored therein, the computer executable code portions comprising program code instructions configured to:
receive a data routing request comprising:
routing context information indicative of (i) a component archetype data structure that defines a data routing strategy for data associated with a component associated with a multi-component system of an application framework and (ii) a partition set identifier that identifies a partition set data structure associated with a set of partitions configured to store the data associated with the component;
determine a component identifier for the component and a partition identifier for a partition of the set of partitions based on the routing context information; and
initiate routing for a data object for the component based on the component identifier and the partition identifier.

9. The computer program product of claim 8, wherein the computer executable code portions comprise the program code instructions configured to:
receive the data routing request via a service proxy communicatively coupled to the apparatus and a client device via a network.

10. The computer program product of claim 8, wherein the computer executable code portions comprise the program code instructions configured to:
query a partition set registry based on the routing context information, wherein the partition set registry defines a relationship mapping between (a) the component archetype data structure, (b) the partition set identifier, (c) the component identifier, and (d) the partition identifier.

11. The computer program product of claim 8, wherein the routing context information is associated with a Hypertext Transfer Protocol (HTTP) header for the data routing request.

12. The computer program product of claim 8, wherein the computer executable code portions comprise the program code instructions configured to:
generate, based on the routing for the data object, a metric data structure that provides dependency metrics associated with the component and one or more other components of the application framework;
generate an application programming interface (API) object based on the metric data structure; and
cause transmission of the API object to a client device via a communication channel of a network that communicatively couples the apparatus and the client device.

13. The computer program product of claim 8, wherein the data routing request further comprises dependency information that defines one or more component dependency relationships between the component and one or more other components associated with the multi-component system of the application framework, and wherein the computer executable code portions comprise the program code instructions configured to:
determine the partition identifier based on the dependency information.

14. The apparatus according to claim 8, wherein the computer executable code portions comprise the program code instructions configured to:
store the data object in the partition based on the component identifier and the partition identifier.

15. A computer-implemented method, comprising:
receiving a data routing request comprising:
a data object for a component associated with a multi-component system of an application framework; and
routing context information indicative of (i) a component archetype data structure that defines a data routing strategy for data associated with the component and (ii) a partition set identifier that identifies a partition set data structure associated with a set of partitions configured to store the data associated with the component;
determining a partition identifier for a partition of the set of partitions based on the routing context information; and
initiating routing for the data object based on the partition identifier and a component identifier for the component.

16. The computer-implemented method of claim 15, further comprising:
receiving the data routing request via a service proxy communicatively coupled to the apparatus and a client device via a network.

17. The computer-implemented method of claim 15, further comprising:
querying a partition set registry based on the routing context information, wherein the partition set registry defines a relationship mapping between (a) the component archetype data structure, (b) the partition set identifier, (c) the component identifier, and (d) the partition identifier.

18. The computer-implemented method of claim 15, wherein the routing context information is associated with a Hypertext Transfer Protocol (HTTP) header for the data routing request.

19. The computer-implemented method of claim 15, further comprising:
generating, based on the routing for the data object, a metric data structure that provides dependency metrics associated with the component and one or more other components of the application framework;
generating an application programming interface (API) object based on the metric data structure; and
causing transmission of the API object to a client device via a communication channel of a network that communicatively couples the apparatus and the client device.

20. The computer-implemented method of claim 15, wherein the data routing request further comprises dependency information that defines one or more component dependency relationships between the component and one or more other components associated with the multi-component system of the application framework, and the computer-implemented method further comprising:
determining the partition identifier based on the dependency information.
